(19) United States
(12) Patent Application Publication
(10) Pub. No.: US 2005/0134894 A1
(43) Pub. Date: Jun. 23, 2005

(54) Remote access printing systems and methods

(75) Inventors: Thomas Wayne Littman, Castle Rock, CO (US); Richard Pretzel, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Information Handling Services Inc., Englewood, CO (US)

(21) Appl. No.: 10/977,541

(22) Filed: Oct. 29, 2004

Related U.S. Application Data
(60) Provisional application No. 60/516,001, filed on Oct. 31, 2003.

(51) Int. Cl. G06F 3/12; G06F 15/00; H04L 9/00

(52) U.S. Cl. 358/1.14; 713/200; 358/1.15

(57) ABSTRACT

A method of delivering a hardcopy of a document to a user via a printer of the user includes receiving a request for the document and creating an electronic file that includes an electronic reproduction of the document and code that interacts with a printer of the user to allow at least one hardcopy of the document to be printed on the printer. The code also prevents the electronic reproduction of the document from being used to print more than a predetermined number of hardcopies of the document. The method also includes sending the electronic file to the user.

### CROSS-REFERENCES TO RELATED APPLICATIONS

This application is a non-provisional of, and claims the benefit of, co-pending, commonly-assigned, Provisional U.S. Patent Application No. 60/516,001, entitled “REMOTE ACCESS PRINTING,” filed on Oct. 31, 2003, by Littman, et al., the entire disclosure of which is herein incorporated for all purposes.

### BACKGROUND OF THE INVENTION

The present invention relates generally to document delivery. More specifically, embodiments of the invention relate to systems and methods for delivering a hard copy of a document via a remote printer.

Many copyrighted documents are distributed in a controlled manner. This can be done in either hard or softcopy. Hard copies, such as a book, are easy to control the copyright as users typically know reproduction of the book is protected. In the case of standards, specifications, and technical publications, they are often printed and mailed for those users wanting a hardcopy.

There exists apparent user confusion, however, when it comes to soft copies of copyrighted documents. Soft copies are delivered in digital form, which makes perfect reproductions easy to produce. Some users have the misconception that soft copies can be disseminated more loosely. Most copyright holders would disagree.

Thus, systems and methods are needed that restrict certain activities with respect to soft copies of copyrighted documents.

### BRIEF SUMMARY OF THE INVENTION

Embodiments of the invention thus provide a method of delivering a hardcopy of a document to a user via a printer of the user. The method includes receiving a request for the document and creating an electronic file that includes an electronic reproduction of the document and code that interacts with a printer of the user to allow at least one hardcopy of the document to be printed on the printer. The code also prevents the electronic reproduction of the document from being used to print more than a predetermined number of hardcopies of the document. The method also includes sending the electronic file to the user.

In some embodiments, the code interacts with the printer of the user via an application operating on a computer of the user. The electronic reproduction of the document may be useable to produce a hardcopy of the document that has substantially the same information on each page as each analogous page in an original document. Sending the electronic file to the user may include storing the file on a File Transfer Protocol server, receiving a download request, and allowing the file to be downloaded. The method may include embedding in the electronic file, code that prevents the electronic reproduction of the document from being viewed after the passage of a predetermined period of time. The request for the document may include an order and the order identifies the predetermined number of times the document can be printed. The file may be a .pdf file. The file may include an executable file. The method may include receiving a message that indicates that the user has attempted to access the file and sending a permissions packet to a computing device of the user.

In other embodiments, an electronic file includes an electronic reproduction of a document and code that interacts with a printer of a user to allow at least one hardcopy of the document to be printed on the printer. The code also prevents the electronic reproduction of the document from being used to print more than a predetermined number of hardcopies of the document.

In some embodiments, the electronic file also includes code that prevents the electronic reproduction of the document from being viewed after the passage of a predetermined period of time. The electronic file may be a .pdf file. The file may be an executable file. The code may be configured to interact with the printer of the user via an application on a computing device associated with the user.

In other embodiments, a system for delivering a hardcopy of a document to a user via a printer of the user includes a server configured to provide an electronic file comprising the document to a computing device of the user. The electronic file includes an electronic reproduction of the document and code that interacts with a printer of the user to allow at least one hardcopy of the document to be printed on the printer. The code also prevents the electronic reproduction of the document from being used to print more than a predetermined number of hardcopies of the document and an interface between the server and the printer of the user. The electronic file further includes code that prevents the electronic reproduction of the document from being viewed after the passage of a predetermined period of time. The code interacts with the printer of the user via an application operating on a computer of the user. The application may be a plug-in. In some embodiments, the application is a standalone application.

In still other embodiments, a computer-readable medium has stored thereon code to render an electronic reproduction of a document on a display and code that interacts with a printer of a user to allow at least one hardcopy of the document to be printed on the printer. The code also prevents the electronic reproduction of the document from being used to print more than a predetermined number of hardcopies of the document. The computer-readable medium also may have stored thereon code that prevents the electronic reproduction of the document from being viewed after the passage of a predetermined period of time. At least a portion of the code may be a .pdf file. At least a portion of the code may be an application installed on a computing device of the user.

In yet other embodiments, a system for delivering a document to a user includes means for providing an electronic file that includes the document to a computing device of the user. The electronic file includes an electronic reproduction of the document and code that interacts with a printer of the user to allow at least one hardcopy of the document to be printed on the printer. The system also includes means associated with the file for programming a computing device to prevent the electronic reproduction of the document from being used to print more than a predetermined number of hardcopies of the document. The system also may include means associated with the file for programming a computing device to prevent the electronic reproduction of the document from being viewed after the passage of a predetermined period of time.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a document delivery system according to embodiments of the invention.

FIG. 2 illustrates a remote access printing method according to embodiments of the invention, which may be implemented in the system of FIG. 1 or other appropriate system.

### DETAILED DESCRIPTION OF THE INVENTION

The ensuing description provides exemplary embodiment(s) only, and is not intended to limit the scope, applicability or configuration of the invention. Rather, the ensuing description of the exemplary embodiment(s) will provide those skilled in the art with an enabling description for implementing embodiments of the invention. It being understood that various changes may be made in the function and arrangement of elements without departing from the spirit and scope of the invention as set forth in the appended claims.

To prevent reproductions that are not authorized by the copyright holder, digital rights management (DRM) techniques have developed. Generally, DRM controls the right to view, print, distribute, and/or the like, soft copies of documents and other content. Limitations could be defined by uses or views, users with access, time periods, etc. Viewing programs and operating systems may be used to enforce the DRM. In some embodiments, ADOBE ACROBAT™ is used to view and print a document with FILEOPEN PUBLISHER™ providing the DRM, but other programs could be used.

Embodiments of the present invention allow local printing of a softcopy of a document. Remote access printing allows hardcopy documents to be delivered to users on-demand. This technology allows copyright owners to have a competitive edge in that users will not have to wait several days to have their documents delivered. Rather than using a ground or air carrier service to deliver the hardcopy documents, remote access printing delivers documents in softcopy form for a predetermined, finite number of hardcopy prints to be made at the location of the user.

In some embodiments, DRM is used to limit the ability to use the softcopy of the document. In some embodiments, the user is limited to viewing and printing the document for a 24 or 72 hour period, which should leave ample time to print the predetermined number of copies. Other embodiments could only allow a single print with limited viewing for a period of time. Yet other embodiments could completely restrict viewing and just allow one or a predetermined number of prints. The software enforcing the DRM could structure the printing and viewing capability in any way acceptable to the copyright holder.

In one example, the copyright holder or its agent sends an ADOBE ACROBA™-readable .pdf softcopy file to the user's computing device via email. When the user opens the file, the file has a limited “life” in which it can be opened and printed by the customer and once the document has been printed (or the allowed time has expired), the file cannot be viewed or printed again. Remote access printing provides the customer with the ability to print only the number of copies purchased and paid for.

In contrast to physical delivery methods, the user may be charged a reduced delivery fee or none at all when the soft copy is remotely accessed and printed locally. The user may be authorized to share the hardcopy after printing. For example, it could be put in a library or shared with a colleague. In contrast, soft copies generally are limited by license to a single user or a group of users.

Note that remote access printing is not the same as purchasing the softcopy file. When a customer purchases the softcopy file of a document, the softcopy file is viewable and/or printable indefinitely from the computer of the user. DRM could limit the use to a computer, a user, and/or an organization. Remote access printing files, in embodiments of the present invention, have a limited life and are designed for the purpose of immediately printing the authorized number of hardcopy documents.

In some embodiments, the copyright holder provides the documents to a distribution agent. The documents could be in hard or softcopy form. Those in hardcopy form are digitized. The user interacts with a web page maintained by the distribution agent to select a document for remote access printing. The softcopy document file is either generated before or after ordering. Some embodiments generate the file after ordering to customize the file for the user by embedding DRM rights and tracking information.

The user may download the file from the web site soon after ordering, or the user may be sent an email with the file or a link to the file attached. The file could be executable itself in a manner that enforces the DRM or could be input into a printing program that enforces the DRM. Where the file relies upon a printing program, the DRM rights that define usage can be determined by the printing program from the file. For example, the file may include the DRM rights or include a code that can be used to look up the DRM rights. In other embodiments, the DRM rights are sent in a rights file associated with the softcopy file such that the printing program can access the rights information locally. Where the softcopy file only has an identifier and the rights information is not available locally, a remote database can be queried for this information.

Once the printing program determines the DRM rights to the softcopy file, it can be accessed for printing and/or viewing. In one embodiment, the user is given the right to view the softcopy file for three days and print the softcopy file once during that time period. Once the rights have expired, the softcopy is no longer usable. The printing program may track the depletion of the rights or query a remote server for authorization each time. Some embodiments try the remote server and only use local tracking when the remote server is unavailable. Some embodiments may allow purchase of additional rights to the softcopy file without downloading a new copy.

Some embodiments do not include a printing program on the computer of the user. These embodiments only use the printing services of the operating system, JAVA™ or ACTIVEX™ virtual machine, web browser, and/or the like. There is no softcopy file provided to the user, except a datastream, ephemeral file, or the like, that is used for printing the softcopy locally. In other words, a print job may be sent directly to a printer or printer queue of the user. The agent of the copyright holder maintains an application service provider model where the software is principally hosted remote to the user's computer. In this embodiment, no printing/viewing program of the user computer is relied upon for the printing. An encrypted channel to the user computer protects the softcopy during delivery.

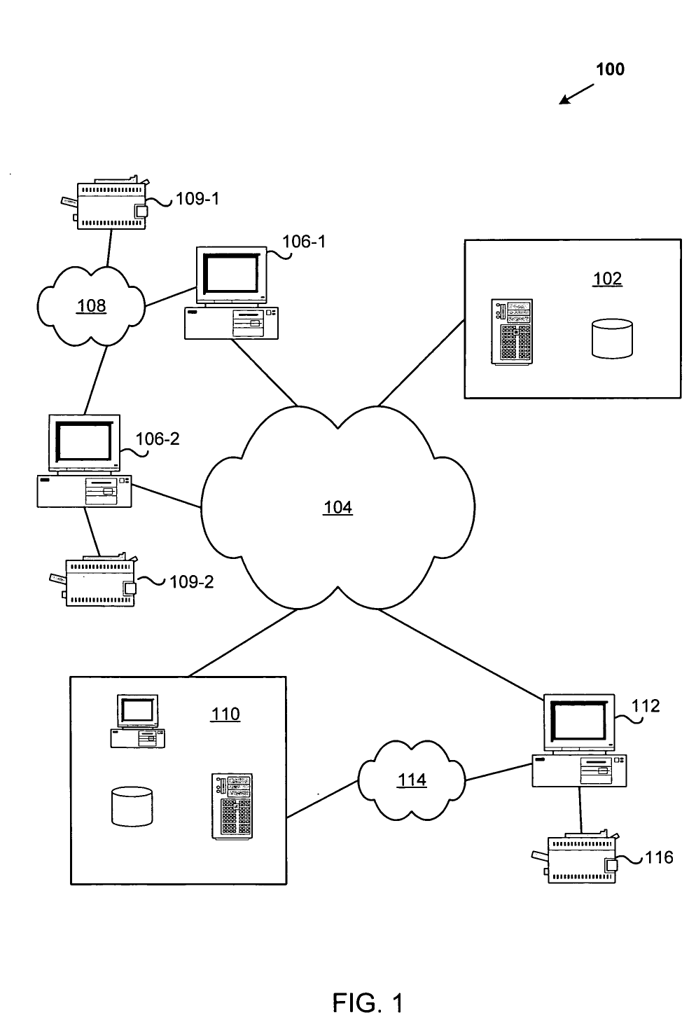

Having described embodiments of the invention generally, attention is directed to FIG. 1, which illustrates an exemplary system 100 according to embodiments of the invention. The system includes a host computer system 102. The host computer system 102 may include any of a number of computing devices, peripheral devices, network devices, input devices, output devices, and the like. The host computer system also may include administrative computers (e.g., personal computers, laptop computers, and the like) that may be used to assist in the operation of the system. The host computer system 102 also may include network interfaces (e.g., web server, FTP server, and the like) that enable communication between the host computer system and external devices. All the devices that comprise the host computer system 102 may be co-located at a single facility or distributed geographically. In a specific embodiment, the host computer system 102 is comprised by a single computing device.

In a specific embodiment, the host computer system 102 includes a server, a data storage arrangement, and a network that allow the two to communicate. The server may be any computing device or combination of computing devices capable of performing the processes described herein. The server includes a processor and software that programs the processor to operate according to the teachings herein. The storage arrangement may be, for example, any magnetic, electronic, or optical storage system, or any combination of these. The storage arrangement may have any combination of RAM, ROM, hard disk drives, optical drives, magnetic tape systems, and the like.

The system also includes a network 104 through which user devices 106 access the host computer system. The network 104 may be any of a number of well known wired or wireless networks or combinations thereof. For example, the network may be a LAN, WAN, intranet, and/or the like. In a specific embodiment, the network is the Internet.

The user devices 106 may be any devices capable of providing a user access to the host computer system 102. In a specific embodiment, the user device 106-2 is a desktop computer through which the user accesses the host computer system, via the Internet, for purposes of ordering and receiving a copyrighted document. The user devices 106-1, 106-2 may be interconnected via a network 108, which may be any wired or wireless network. In some embodiments, the network 108 is comprised by the network 104.

In some embodiments, the user devices 106 each include a processor and application code, either hardware, firmware, and/or software, that programs the device to perform the functions described herein. For example, a user device may include a web browser, ADOBE ACROBAT™, FILEOPEN PUBLISHER™, JAVA™, ACTIVEX™ virtual machine, and/or the like. The application code works in combination with a file that includes a soft copy of a document and that implements DRM.

The system 100 also includes printing devices 109 either directly connected to a user device 106-2 or networked to a user device 106-1. The printing devices 109 may receive print jobs from a computing device 106 or from the host computer system 102. The printing devices may be any device capable of creating a hard copy of a document.

The system 100 may include a reseller system 110, which may include servers, data storage devices, computing devices and the like. As will be described in more detail hereinafter, the reseller system 110 may purchase softcopies of copyrighted documents, or links thereto, for resale to secondary users via a secondary network 114. The secondary network 114 may be any wired or wireless network, and may be comprised by the network 104. Secondary users may access the reseller system 110 via secondary user devices 112, which may be any suitable computing device. The a secondary user device 112 may have a printing device 116 associated with it and may include application code as described above with respect to the user devices 106.

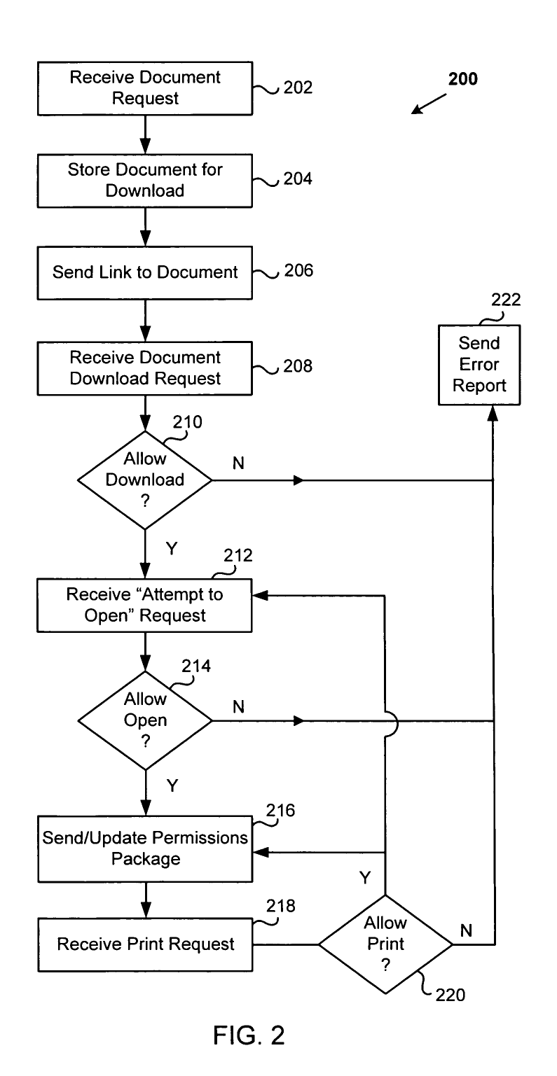

Having described an exemplary system 100 according to embodiments of the invention, attention is directed to FIG. 2, which illustrates an exemplary method 200 according to embodiments of the invention. The method may be implemented in the system 100 described above or in another suitable system. Those skilled in the art will appreciate that alternative methods according to embodiments of the invention may include more, fewer, or different steps than those illustrated and described herein, and steps may be performed in different orders than that described with respect to this exemplary embodiment.

The method 200 begins when a document request is received at step 202. The request may comprise an order received at the host computer system from a user device 106 or a reseller system 110, for example. As those skilled in the art will appreciate, the request may be received, for example, via an e-commerce web site, facsimile machine, voice response unit, and/or the like. In a specific embodiments, users interact with the host computer system 102 via web pages rendered on a user device 106. The web pages may include search features, cataloging systems, and the like, that assist the user to locate desired documents and place orders. The process may be assisted through the use of a “shopping cart” ordering model or other suitable ordering system.

At block 204, for each document requested at block 202, a file comprising an electronic reproduction of the document is stored for download. The file may be in any of a variety of formats and may include various restrictions (e.g., DRM), and the like. For example, a file may be encoded or otherwise inaccessible without the use of an external application, passcode, password, and/or the like. In a specific embodiment, the file is in .pdf format that is viewable through the assistance of code operating on the user's computer but also includes code and/or formatting that require an associated permissions package. In some embodiments, the file is self-executing.

In some embodiments, the electronic reproduction is a page-rendered reproduction of the document. In other words, the electronic reproduction is imaged, paginated, or otherwise indexed, so that, when printed, the hardcopy appears identical to or substantially similar to the original document, having generally the same information on each page as the original, including headers, footers, page numbers, special characters, and the like. For example, .pdf files created by ADOBE ACROBAT™ are electronic reproductions. This method of creating electronic reproductions is particularly useful with respect to the delivery of specifications, standards, and the like, for which page references are important.

The document may be stored, for example, on a File Transfer Protocol (FTP) server or the like. Once stored, a link to the document may be created and emailed or otherwise transferred to the requesting user at block 206.

It should be appreciated that, rather than storing the document and sending a link to it, an electronic copy of the document may be sent to the requester. This would eliminate the download step to be described immediately hereinafter.

At block 208, a download request for the document is received from the user and a decision is made at block 210 whether to allow the download. The criteria for the decision may include an identification check in which the user enters a password, order number, or the like. In some embodiments, the user's IP address may be checked against an IP address included in the order, or the like. The criteria also may include a date/time check that prevents download after the passage of a pre-determined period of time, for example, three days. Other criteria also or alternatively may be included. If the download is allowed, the method continues at block 212.

Those skilled in the art will appreciate that the process described in the preceding several steps may comprise, in a specific embodiment, an exchange whereby a user, having located a specific document via a web site, submits an order for the document. The order may include payment information, the user's email address, and/or the like. An email is sent to the user in which a hyperlink to the document's location on a FTP server is included. The email may include a password or other identifier that limits access to the stored document. The user clicks the link, provides the password, and the user's browser points to the document and queries the user whether the user wishes to SAVE or DOWNLOAD the file. The process then may proceed at block 212 as described below.

Continuing with the method 200, at block 212 an “attempt to open” request is received at the host computer system 102. This occurs as a result of the user initiating viewing of the document using the user device 106 and is triggered by, for example, code embedded in the file comprising the document in combination with a viewing utility.

At block 214, a decision is made whether to allow the user to open the document. In some embodiments, the user is given only a pre-determined period of time in which to open the document after downloading or receiving it. Thus, one of the decision factors may be checking whether that period of time has been exceeded. In some embodiments, the document can only be opened on the computer to which it was downloaded, in which case the criteria may include checks to verify this. Many other examples are possible.

If the user is allowed to open the document, the method continues at block 216. At this point, a permissions package is transferred from the host computer 102 to the user device 106. The permissions package may include a password, encoded access restrictions, and or the like. Thus, the permissions package may operate in combination with a viewing utility to prevent the user from violating the document owner's copyright. In a specific embodiment, the permissions package works in combination with FILEOPEN PUBLISHER™ and ADOBE ACROBAT™ to allow viewing and/or printing of the document. In some embodiments, otherwise operable features of the commercially-available applications (e.g., cut, paste, and/or the like) may be disabled.

The permissions package may operate to prevent a document from being accessible if the file comprising it is transferred from one user device (e.g., the user device 106-2) to a second user device (e.g., the user device 106-1). In other words, the file comprising the document may, in some embodiments, be transferred or copied freely from user device to user device before the file or a copy of it is opened. In other embodiments, this is not allowed. Once a user attempts to open or otherwise access the file, however, the permissions package is downloaded to the user device on which the file is presently located, thereafter preventing the document from being accessed at other user devices.

In some embodiments, no further interaction with the host computer system 102 is required. In other embodiments, however, when a user attempts to print the document, a print request is received at the host computer system at block 218. Thereafter, a decision whether to allow the print is made at block 220. This decision also may be made in embodiments that do not contact the host computer system 102 for printing. In other words, the decision at block 220 may take place at the user device or at the host computer system.

Criteria for the decision at block 220 may include: evaluating whether the user device attempting to print the document includes a permissions package; evaluating whether a predetermined number of allowed prints has been exceeded; evaluating whether a predetermined period of time has elapsed from the time the document was first accessed; and/or the like. If printing is not allowed, an error report may be sent to the user and/or host computer at block 222. Similar error reports may be sent if any of the prior decisions (blocks 210, 214) prevent access to the document. Of course, if the print is allowed, the method concludes successfully or continues to allow prints until the predetermined number of allowed prints has been achieved. This may comprise updating the permissions package each time a document is printed.

Other errors (e.g., printer jam) may generate the need to contact the agent of the copyright holder, in which case the agent may send another file comprising the document, another link to a file comprising the document, enable the file to be downloaded again using the previous link, and/or the like. The agent also or alternatively update the permissions package to allow printing again. The agent also may update the permissions package in response to another order from the user, thus preventing the need to re-download the file if the user needs additional copies.

Those skilled in the art will appreciate a number of other exemplary embodiments in light of this disclosure. For example, in some embodiments, the file comprising the document may be freely copied, transferred, and opened at multiple user devices. Each time it is accessed, a permissions package is downloaded to the user device until a predetermined number of permissions packages have been downloaded in relation to the original file. Each instance of the file may allow one or more prints and may exist only for a predetermined period of time. Such embodiments are advantageous, among other reasons, for distributing hard copies to each member of an organization. The members of the organization may be spread across a vast geographic area.

In some embodiments, a reseller 110 purchases an inventory from the agent of the copyright holder via the host computer system 102. The inventory may include actual files comprising the document or links to document locations at a server (e.g., an FTP server). The reseller may thereafter sell a link or document to secondary purchaser at the secondary user device 112. Thereafter, the method may work similar to the method 200 described above. Of course, minor variations may include that the reseller does not request and/or receive the link or document until after the secondary user submits an order. This skilled in the art will appreciate may other variations in light of this description.

In some embodiments, a print job is sent directly to a printer 109, 116 of either a user or secondary user. Such embodiments may eliminate the need for any dedicated code on the user device.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. For example, those skilled in the art know how to arrange computers into a network and enable communication among the computers. Accordingly, the above description should not be taken as limiting the scope of the invention, which is defined in the following claims.

1. A method of delivering a hardcopy of a document to a user via a printer of the user, comprising:
receiving a request for the document;
creating an electronic file comprising:
an electronic reproduction of the document; and
code that interacts with a printer of the user to allow at least one hardcopy of the document to be printed on the printer, wherein the code also prevents the electronic reproduction of the document from being used to print more than a predetermined number of hardcopies of the document; and
sending the electronic file to the user.

2. The method of claim 1, wherein the code interacts with the printer of the user via an application operating on a computer of the user.

3. The method of claim 1, wherein the electronic reproduction of the document is useable to produce a hardcopy of the document that has substantially the same information on each page as each analogous page in an original document.

4. The method of claim 1, wherein sending the electronic file to the user comprises:
storing the file on a File Transfer Protocol server;
receiving a download request; and
allowing the file to be downloaded.

5. The method of claim 1, further comprising embedding in the electronic file, code that prevents the electronic reproduction of the document from being viewed after the passage of a predetermined period of time.

6. The method of claim 1, wherein the request for the document comprises an order and the order identifies the predetermined number of times the document can be printed.

7. The method of claim 1, wherein the file comprises a .pdf file.

8. The method of claim 1, wherein the file comprises an executable file.

9. The method of claim 1, further comprising:
receiving a message that indicates that the user has attempted to access the file; and
sending a permissions packet to a computing device of the user.

10. An electronic file, comprising:
an electronic reproduction of a document; and
code that interacts with a printer of a user to allow at least one hardcopy of the document to be printed on the printer, wherein the code also prevents the electronic reproduction of the document from being used to print more than a predetermined number of hardcopies of the document.

11. The electronic file of claim 10, further comprising code that prevents the electronic reproduction of the document from being viewed after the passage of a predetermined period of time.

12. The electronic file of claim 10, wherein the electronic file comprises a .pdf file.

13. The electronic file of claim 10, wherein the file comprises an executable file.

14. The electronic file of claim 10, wherein the code is configured to interact with the printer of the user via an application on a computing device associated with the user.

15. A system for delivering a hardcopy of a document to a user via a printer of the user, comprising:
a server configured to provide an electronic file comprising the document to a computing device of the user, wherein the electronic file comprises:
an electronic reproduction of the document; and
code that interacts with a printer of the user to allow at least one hardcopy of the document to be printed on the printer, wherein the code also prevents the electronic reproduction of the document from being used to print more than a predetermined number of hardcopies of the document; and
an interface between the server and the printer of the user.

16. The system of claim 15, wherein the electronic file further comprises code that prevents the electronic reproduction of the document from being viewed after the passage of a predetermined period of time.

17. The system of claim 15, wherein the code interacts with the printer of the user via an application operating on a computer of the user.

18. The system of claim 17, wherein the application comprises a plug-in.

19. The system of claim 17, wherein the application comprises a standalone application.

20. A computer-readable medium having stored thereon:
code to render an electronic reproduction of a document on a display; and
code that interacts with a printer of a user to allow at least one hardcopy of the document to be printed on the printer, wherein the code also prevents the electronic reproduction of the document from being used to print more than a predetermined number of hardcopies of the document.

21. The computer-readable medium of claim 20, further comprising code that prevents the electronic reproduction of the document from being viewed after the passage of a predetermined period of time.

22. The computer-readable medium of claim 20, wherein at least a portion of the code is comprised by a .pdf file.

23. The computer-readable medium of claim 20, wherein at least a portion of the code is comprised by an application installed on a computing device of the user.

24. A system for delivering a document to a user, comprising:
means for providing an electronic file comprising the document to a computing device of the user, wherein the electronic file comprises:
an electronic reproduction of the document; and
code that interacts with a printer of the user to allow at least one hardcopy of the document to be printed on the printer; and
means associated with the file for programming a computing device to prevent the electronic reproduction of the document from being used to print more than a predetermined number of hardcopies of the document.

25. The system of claim 24, further comprising means associated with the file for programming a computing device to prevent the electronic reproduction of the document from being viewed after the passage of a predetermined period of time.
